(19) United States
(12) Patent Application Publication
(10) Pub. No.: US 2016/0365182 A1
(43) Pub. Date: Dec. 15, 2016

(54) SUPERCONDUCTING MAGNETIC ENERGY STORAGE

(71) Applicant: Rolls-Royce North American Technologies, Inc., Indianapolis, IN (US)

(72) Inventor: Michael James Armstrong, Avon, IN (US)

(21) Appl. No.: 15/178,083

(22) Filed: Jun. 9, 2016

Related U.S. Application Data
(60) Provisional application No. 62/174,076, filed on Jun. 11, 2015.

(51) Int. Cl. H01F 6/06; H01F 6/00; H01F 6/04

(52) U.S. Cl. CPC H01F 6/06; H01F 6/04; H01F 6/006

(57) ABSTRACT

A superconducting magnetic energy storage (SMES) device including a toroidal housing and a coil. The toroidal housing is configured to store a cryogenic fluid that cools the SMES to a superconducting state. The coil is configured to be in the superconducting state from cooling from the cryogenic fluid. The coil is also configured to store power for delivery to one or more external devices.

This application claims the benefit of U.S. Provisional Application No. 62/174,076 filed Jun. 11, 2015, which is incorporated herein by reference in its entirety.

### TECHNICAL FIELD

The present disclosure relates to energy storage devices, and more particularly, to superconducting magnetic energy storage devices (SMES).

### BACKGROUND

Superconducting magnetic energy storage (SMES) devices store energy in a magnetic field. The SMES includes a coil that is cooled below the superconducting temperature and functions in a superconducting state at such a temperature. The magnetic field is created by the flow of direct current in the superconducting coil.

### SUMMARY

In some examples, the disclosure describes a superconducting magnetic energy storage (SMES) device including a toroidal housing and a coil. The toroidal housing is configured to store a cryogenic fluid that cools the SMES to a superconducting state. The coil is configured to be in the superconducting state from cooling from the cryogenic fluid. The coil may also be configured to store power for delivery to one or more external devices.

In some examples, the disclosure describes a system including a controller, a gas pressurization tank, a power converter, and a superconducting magnetic energy storage (SMES) device. The SMES includes a cryogenic fluid, a toroidal housing, and a coil. The cryogenic fluid cools the SMES to a superconducting state. The toroidal housing is configured to store the cryogenic fluid. The coil is configured to be in the superconducting state from cooling from the cryogenic fluid. The coil is further configured to store power for delivery to one or more external devices.

In some examples, the disclosure describes a method for operating a superconducting magnetic energy storage (SMES) device. The method includes storing, in the SMES device, a cryogenic fluid that cools the SMES to a superconducting state. The method also includes storing, with the SMES device being in the superconducting state, power for delivery to one or more external devices.

The details of one or more examples of this disclosure are set forth in the accompanying drawings and the description below. Other features, objects, and advantages of this disclosure will be apparent from the description and drawings, and from the claims.

### BRIEF DESCRIPTION OF DRAWINGS

FIG. 1 is a block diagram illustrating an example energy delivery system.

FIGS. 2A and 2B are cross-sectional diagrams illustrating an example superconducting magnetic energy storage (SMES) device.

FIG. 2C is a plan view diagram illustrating an example superconducting magnetic energy storage (SMES) device.

FIG. 3 is a schematic block diagram illustrating an example superconducting magnetic energy storage (SMES) device.

FIG. 4 is a flow diagram illustrating example techniques for superconducting magnetic energy storage (SMES).

### DETAILED DESCRIPTION

Superconducting magnetic energy storage (SMES) devices store energy in a magnetic field. SMES devices include a superconductor wound around a core, to form a coil, and at cryogenic temperatures the coil functions in a superconducting state. For example, the superconducting coil is cryogenically cooled bringing it into the superconducting state, such that the resistivity of the wire approaches zero (i.e., the coil has virtually no electrical resistance) and does not lose energy in the form of heat.

The SMES device operates in three modes set by the operation of power electronics equipment (e.g., a controller as described in more detail below). The SMES device stores energy in a magnetic field in a charge mode and a maintain mode, and dissipates the energy in a discharge mode. In a charge mode, current flows from a positive node to a negative node (or ground) via the winding of the SMES device. In a maintain mode, the current is diverted to circulate through the winding of the SMES device. In a discharge mode, the current is outputted to deliver power.

The flow of current through the winding during the charge mode creates a magnetic field. In the superconducting state, there is little loss in the current flowing through the winding meaning that the magnetic field is preserved in the maintain mode through the circulation of current in the winding. In this manner, the SMES device stores energy in a form of a magnetic field. Then, in the discharge mode, current flows out of the SMES device collapsing the magnetic field.

As a result, SMES devices allow virtually lossless energy storage in the superconducting state, while allowing for extremely fast charge and discharge capability. Because of these benefits of SMES devices, including the benefit that SMES devices function at cryogenic temperatures, SMES devices may be utilized to store relatively high amounts of energy and for rapid delivery of such energy.

SMES devices are typically cooled by bathing the SMES device in a tank of cryogenic fluid. The external tank of cryogenic fluid requires a large volume of space. Because space may be limited in potential SMES applications, the size of a SMES device and the energy stored in the SMES device is also limited.

The techniques described in this disclosure describe examples of SMES devices that reduce the total volume of space required to store a given amount of energy. In examples described in this disclosure, an SMES device may itself internally store the cryogenic fluid, rather than being placed in the tank of cryogenic fluid. Storing cryogenic fluid inside an SMES device may reduce the physical space required by the SMES device because it does not require a tank of cryogenic fluid. Likewise, storing cryogenic fluid inside a SMES device may allow use of a larger SMES in the same physical space that would otherwise be used by a tank of cryogenic fluid, thus storing more energy.

As described in more detail, in some examples, the cryogenic fluid stored inside the SMES device may include a cryogenic fuel such as liquid hydrogen such that the SMES device may also be used as a fuel tank. As a result, the SMES device may be used for dual purposes, namely storing energy in a magnetic field and in liquid form, thus storing more energy in a given physical space. Further, storing cryogenic fluid within the SMES device may counter the stress created by the superconducting coil on the surface of the SMES device by supporting the structure of the SMES device from the interior of the SMES device. This may further reduce the physical space required to store both electrical and chemical energy by combining the two storage systems.

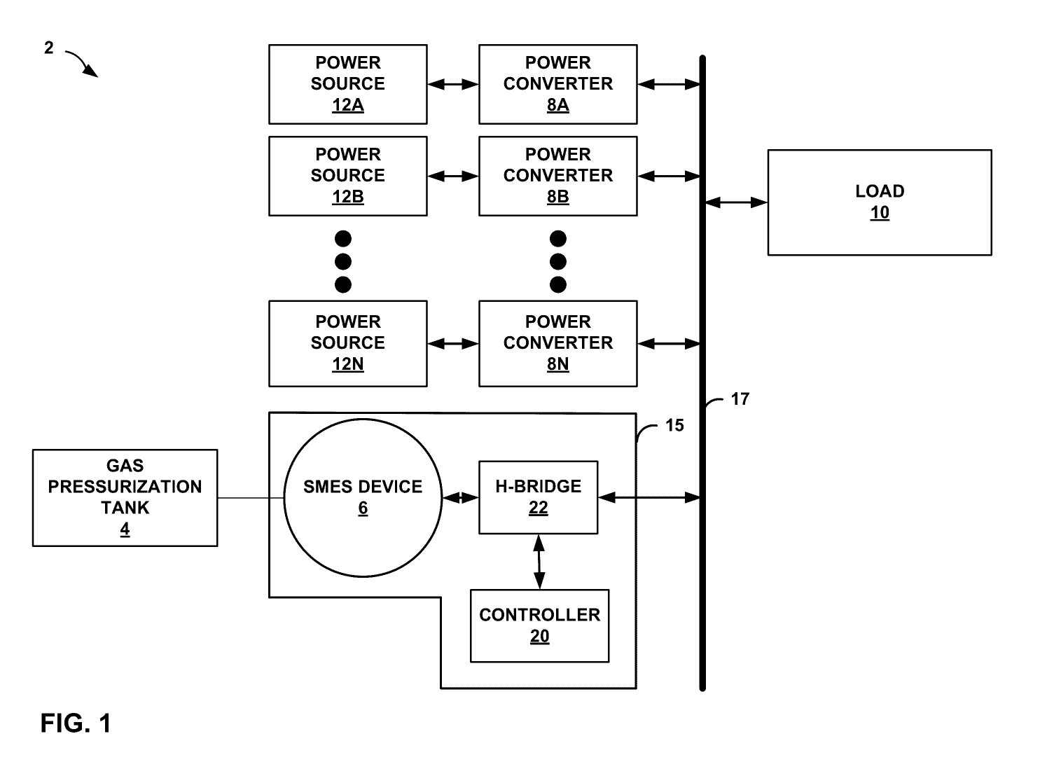

FIG. 1 is a block diagram illustrating an example energy delivery system. Energy delivery system 2 includes gas pressurization tank 4, power sources 12A-12N, power converters 8A-8N, supplemental power source 15 that includes superconducting magnetic energy storage (SMES) device 6 and controller 20, DC bus 17, and load 10. Energy delivery system 2 may be part of a jet engine of an airplane or part of an engine of a ship such as a jet engine or ship engine configured to function in a super cooled, superconducting state.

Power sources 12A-12N (collectively referred to as power sources 12) may provide electrical power to devices of energy delivery system 2 and more generally to the other devices on the airplane or ship via power converters 8. Power sources 12 may each deliver a respective fraction of the needed power (e.g., half if only two power sources), but may be capable of delivering all of the needed power. In this way, if one of power sources 12 is unable to provide power (e.g., due to a malfunction), the other ones of power sources 12 can still power all devices, including in the case where all but one power source 12 malfunctions. In some examples, one of power sources 12 may be the primary power source, and the others the redundant power sources. In such examples, in response to the primary power source being unable to provide power, the redundant power sources provide power. In some examples, multiple power sources 12 may not be necessary, and a single power source 12 may be sufficient. Examples of power sources 12 include batteries, solar panels, gas generators, and any other type of devices or utilities that can provide power.

Power converters 8A-8N (collectively referred to as power converters 8) may receive AC power from respective power sources 12 and output DC power (e.g., a DC current) to DC bus 17. Load 10 and SMES device 6 receive the DC current from DC bus 17. In examples where power sources 12 output DC power, power converters 8 may not be needed.

Examples of load 10 include a motor used to drive a propeller. In general, load 10 may be any device that receives electrical current from power converter 14 and for which supplemental power source 15 provides supplemental power. Load 10 may include any device that consumes power, such as motors of vehicles or aircraft, computing devices, lighting, or any other type of device that requires a voltage or current to operate. In some examples, load 10 may include hydrogen powered automobiles, spacecraft, rockets, or other hydrogen powered device.

If one of power sources 12 were to not be able to deliver power, there is a delay before the other one of power sources 12 can deliver all the power needed by the components (e.g., by load 10). Supplemental power source 15 may be configured to deliver the needed power to load 10 during such a switch over time. Because load 10 may consume a relatively large amount of power, supplemental power source 15 may be configured to deliver such a relatively large amount of power in a relatively short amount of time.

For instance, as illustrated, supplemental power source 15 (also referred to as an uninterruptible power supply (UPS)) includes SMES device 6 and controller 20. SMES device 6 stores energy in form of a magnetic field, and that energy can be delivered as a current to power load 10. Controller 20 is configured to cause SMES device 6 to store the energy and cause SMES device 6 to deliver the current.

In some examples, in addition to or instead of acting as UPS, SMES device 6 acts as a ‘peaking’ unit where during short durations SMES device 6 is used to augment existing power sources (e.g., power from one or both of power sources 12). For example, power sources 12 may be formed as gas turbines that provide the main source of power, but during certain maneuvers SMES device 6 provides a short, temporary source of power rather than trying to extract power from the gas turbine (e.g., one or more of power sources 12). This would allow the gas turbine to avoid harsh transients, and may also be useful for examples of load 10 that come on/off quickly or for times when propulsion has to increase for only a short time.

Controller 20 may include any of a various types of discrete or analog circuitry (including integrated circuitry and/or programmable circuitry) for controlling components in different electrical paths through SMES device 6. SMES device 6 may be well suited for storing large amounts of energy that needs to be delivered in a relatively short amount of time. For example, SMES device 6 may be configured to store greater than or equal to approximately tens mega-Joules (MJ), and possibly hundreds of MJ, of energy in a compact package that can be rapidly discharged, but storage of less or more energy is also contemplated.

Moreover, the components of energy delivery system 2 may be cryogenically cooled to a temperature dependent on the cryogen selected and the superconducting material to function in a superconducting state. It has been found that in a superconducting state the mass and/or size of various components such as power sources 12 and load 10 can be reduced, which may be beneficial for airplanes or ships.

SMES device 6 stores energy when SMES device 6 is configured in a superconducting state, which occurs when the wires of SMES device 6 are cooled to cryogenic temperatures. Because load 10 is, in some examples, already cooled to function at cryogenic temperatures, load 10 may directly interface with SMES device 6, which is also cryogenically cooled. For instance, rather than SMES device 6, if a battery backup that functions at room temperature were utilized for backup power, then additional interface components may be needed to interface load 10 to such a battery backup, which increases weight and cost.

As described above, SMES device 6 stores energy in the form of a magnetic field. For instance, SMES device 6 includes a superconductor wound around a core to form a winding around the core. SMES device 6 receives electrical power from power converter 14 and stores the power in the form of electromagnetic energy for purposes of delivering backup power or peaking power. The term “supplemental power” is used to refer generically to backup power or peaking power.

Power converter 14 may provide a direct current to the winding of SMES device 6. Controller 20 configures electrical paths through SMES device 6 to a charge mode to allow current to flow through SMES device 6 causing SMES device 6 to create a magnetic field which is produced as the direct current flows through the winding. After a current is induced in the superconducting coil, controller 20 configures electrical paths through SMES device 6 to a maintain mode to short the winding and allow the current to circulate within the winding (e.g., no new electrons enter the winding). Thus SMES device 6 acts as a battery, storing energy in the magnetic field until the energy is required at some point in the future. Also, due to SMES device 6 being in the superconducting state, little to no current is lost and no power is lost from heat.

Later, when the stored energy is required by load 10, controller 20 configures electrical paths through SMES device 6 to a discharge mode to interrupt the direct current circulating in the winding and cause the current to flow to load 10 (e.g., via power converter 14 or possibly directly to load 10). In this way, during the charge mode, SMES device 6 creates a magnetic field, and in the maintain mode (also referred to as a steady-state mode), SMES device 6 stores energy in form of the magnetic field, and then in the discharge mode, the magnetic field collapses and the current flows out of SMES device 6.

In some examples, controller 20 may control the states of the SMES device 6 using an H-bridge configuration (i.e., H-bridge 22) that includes diodes and switches. For example, controller 20 may selectively open and close switches in such an H-bridge 22 to transition SMES device 6 from the charge mode to the maintain mode and from the maintain mode to the discharge mode.

For instance, after a current is induced in the superconducting winding, controller 20 may short H-bridge 22 so that the direct current circulates in the winding of SMES device 6. When there is a need for the energy stored in SMES device 6, controller 20 may open H-bridge 22 such that there is no longer a short in the circuit. Current from SMES device 16 may then flow to load 18. In this way, SMES device 16 is configured to deliver the stored energy to load 18 (e.g., a motor) in response to one of power sources 12A-12N turning off or in response to a need for peaking power (e.g., controller 20 may control SMES device 16 through the charge, maintain, and discharge modes for peaking power for short durations). In other words, SMES device 16 is configured to provide supplemental power as needed.

Gas pressurization tank 4 may include pressurized gas that may be input to SMES device 6. The pressurized gas may be chosen based on the cooling requirements of power system 2 and the boiling point for a particular element. For example, if SMES device 6 is to be cooled below approximately 23 Kelvin, the pressurized gas may include helium (since helium's boiling point is approximately 4 K). Other gases may be chosen depending on the temperature required to maintain superconductivity in power system 2. Gaseous pressurization may provide benefits to cryogenic fuel storage and SMES. First, it may provide a mechanism for reducing the forces on the SMES structure imposed by the magnetic field. Additionally, gaseous pressurization may be used to force delivery of the cryogenic fuel from the SMES tank without relying on fuel boil-off

In some examples, it may be beneficial to transport cryogenic fluid from SMES device 6 to load 10 and power source 12 (e.g., SMES device 6 provides power to a cryo-cooled generator). Thus, the electrical wires connecting SMES device 6 and load 10 may include superconducting wires. For example, the superconducting electrical wires may be bathed in cryogenic fluid. As a result, the electrical wires may provide simultaneous electrical and cryogenic fluid distribution, which may enable efficient distribution of current between SMES device 6 and load 10 while enabling flow of a cryogenic fluid along the same distribution path.

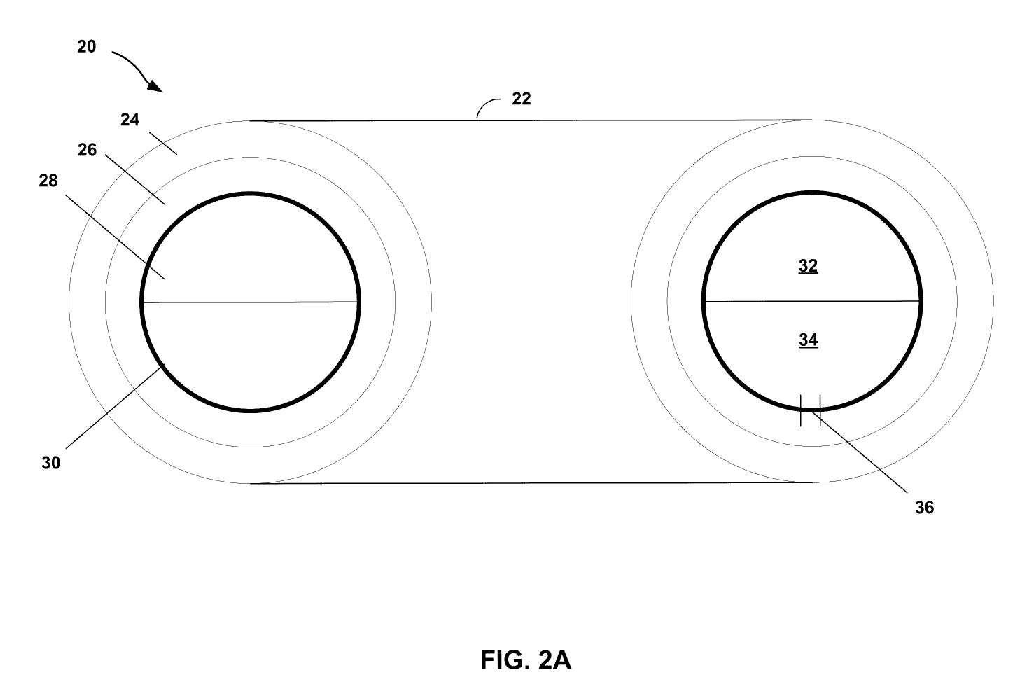

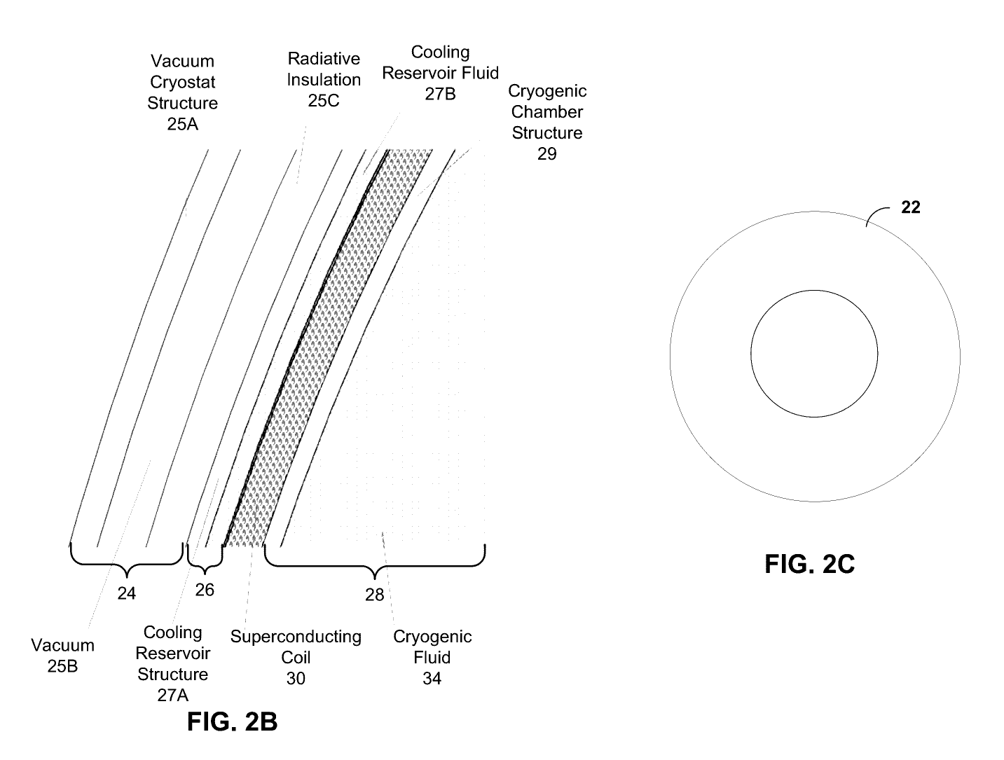

FIGS. 2A and 2B are cross-sectional diagrams illustrating an example superconducting magnetic energy storage (SMES) device. FIG. 2C is a plan view diagram illustrating an example superconducting magnetic energy storage (SMES) device. SMES 20 may include housing 22, superconducting coil 30, and cryogenic fluid 34.

Housing 22 may include high strength metals, such as high strength steel alloys (e.g., ferrite, austenite, graphite, etc.). Housing 22 may include a composite material, such as a high strength, low temperature composite (e.g., zylon fiber epoxy composite). Housing 22 may include a variety of shapes, such as a toroid, donut-shape, or any other shape suitable for generating and storing a magnetic field. In some examples, SMES 20 may include a hollow interior. At least a portion of toroid housing 22 may be hollow such that housing 22 may be used as a storage device. The interior of SMES 20 may include a vacuum. In some examples, the interior may include fluid and/or pressurized gas. For example, where housing 22 includes a hollow toroid, housing 22 may be used to store fluid.

SMES 20 may include a plurality of chambers. For example, SMES 20 may be partitioned to include vacuum cryostat 24 and cryogenic chamber 28. In some examples, SMES 20 may include cooling reservoir 26. In some examples, the plurality of chambers may be positioned in concentric shapes within housing 22. As illustrated in FIG. 2A, vacuum cryostat 24 and cooling reservoir 26 have approximately the same thickness. However, FIGS. 2A-2C are not necessarily drawn to scale, such that cryogenic chamber 28 may occupy more volume than shown in FIGS. 2A-2B while cooling reservoir 26 may occupy less volume than shown in FIGS. 2A-2B. For example, cooling reservoir 26 may be approximately the same thickness as vacuum cryostat 24, may include a thin layer of cryogenic fluid 34, or may be any suitable thickness to assist in cooling superconducting coil 30.

Vacuum cryostat 24 includes a vacuum cryostat structure 25A, which may include high strength metals or a composite material, as described above with reference to housing 22. Vacuum cryostat structure 25A may include the outer layer of housing 22. Vacuum cryostat 24 includes vacuum (or near vacuum) region 25B that is used to prevent external heat sources from heating cryogenic fluid 34 and superconducting coil 30. Vacuum cryostat 24 may include radiative insulation 25C including radiation resistant material, such as mylar, which may help reduce heat transfer from radiation. Vacuum cryostat 24 may not be necessary in every example.

In some examples, cryogenic chamber 28 includes cryogenic chamber structure 29., which may include high strength metals or a composite material, as described above with reference to housing 22. Cryogenic chamber 28 may include pressurized gas 32 and cryogenic fluid 34. Cryogenic chamber 28 may include sub-chambers, for example, pressurized gas 32 and cryogenic fluid 34 may be separated by a physical barrier. Pressurized gas 32 may include gaseous helium, gaseous hydrogen, or gaseous nitrogen. Cryogenic fluid 34 may be pressurized, and may include liquid helium. In some examples, cryogenic fluid 34 may include fuel that may be used to power an engine (e.g., load 10). For example, cryogenic fluid 34 may include liquid hydrogen, liquid helium, or liquid natural gas. In some instances, cryogenic fluid 34 may include liquid helium and pressurized gas 32 may include gaseous helium. In some examples, cryogenic fluid 34 may include liquid hydrogen and pressurized gas 32 may include gaseous helium or gaseous hydrogen. Cryogenic fluid 34 may boil to produce pressurized gas 32. However, in some examples, pressurized gas 32 may include gas from gas pressurization tank 4.

For illustration purposes only, FIG. 2A shows equal volume of pressurized gas 32 and cryogenic fluid 34. However, it is to be understood that cryogenic chamber 20 does not necessarily include a physical barrier between pressurized gas 32 and cryogenic fluid 34, nor are there necessarily equal volumes of pressurized gas 32 and cryogenic fluid 34. Instead, cryogenic chamber 28 may be filled almost entirely with cryogenic fluid 34 and may not include any, or a relatively small amount of, pressurized gas 32. If cryogenic fluid 34 is used as fuel, the volume of cryogenic fluid 34 decreases as the fuel is consumed such that space occupied by pressurized gas 32 increases. In some examples, additional pressurized gas 32 may be pumped into cryogenic chamber 28 as cryogenic fluid 34 is consumed (e.g., by gas pressurization tank 4).

In some examples, SMES 20 may include cooling reservoir 26 and a transfer port 36. Cooling reservoir 26 includes cooling reservoir structure 27A and cooling reservoir fluid 27B. Cooling reservoir fluid 27B cools superconducting coil 30. Transfer port 36 may include an opening between cryogenic chamber 28 and cooling reservoir 26, which may enable cryogenic fluid 34 to flow between cryogenic chamber 28 and cooling reservoir 26. For example, where cryogenic fluid 34 includes liquid hydrogen, cooling reservoir fluid 27B may include cryogenic fluid 34 that drains from cryogenic chamber 28 to cooling reservoir 26 to cool superconducting coil 30. Cooling reservoir fluid 27B may then be transported from cooling reservoir 26 to an engine (e.g., load 10). In some examples, transfer port 36 may be situated so as to evacuate pressurized gas 32 from cryogenic chamber 28 to cooling reservoir 26, such that cooling reservoir fluid 27B may include pressurized gas 32.

Superconducting coil 30 may be located within SMES 20. For example, superconducting coil 30 may be affixed on the outer surface of cryogenic chamber 28 (e.g., cryogenic chamber structure 29). Cryogenic fluid 34 within cryogenic chamber 28 may cool the interior surface of cryogenic chamber 28, which in turn may cool superconducting coil 30. In some examples, where SMES 20 includes cooling reservoir 26, cryogenic fluid 34 may drain from cryogenic chamber 28 into cooling reservoir 26, such that superconducting coil 30 is also cooled via direct contact with cryogenic fluid 34 (labeled as cooling reservoir fluid 27B once fluid 34 flows into cooling reservoir 26) inside cooling reservoir 26.

In operation, cryogenic fluid 34 stored in cryogenic chamber 28 cools superconducting coil 30. A current may be induced in superconducting coil 30 by an outside power source, which generates a magnetic field in SMES 20. Once sufficient current is generated in superconducting coil 30, superconducting coil 30 may be disconnected from the outside power source, for example, by shorting H-bridge 22. As a result, current may flow through superconducting coil 30 indefinitely.

Further, in some examples, cryogenic chamber 28 may be used as a fuel tank and cryogenic fluid 34 may provide fuel to an engine or fuel cell. For example, SMES 20 may act as a cryogenic fuel tank, storing liquid hydrogen in cryogenic chamber 28, such that the liquid hydrogen may fuel an engine.

As a result, the liquid hydrogen may, in some examples, cool superconducting coil 30 to a superconducting state in order to store energy in a magnetic field, while simultaneously providing fuel to an engine (e.g., load 10 that is also in a superconducting state from the cooling from the liquid hydrogen). Thus, SMES 20 may store two forms of energy (e.g., electromagnetic and fuel) in the same volume of space, which may allow for smaller fuel tanks or more energy storage in a given volume of space.

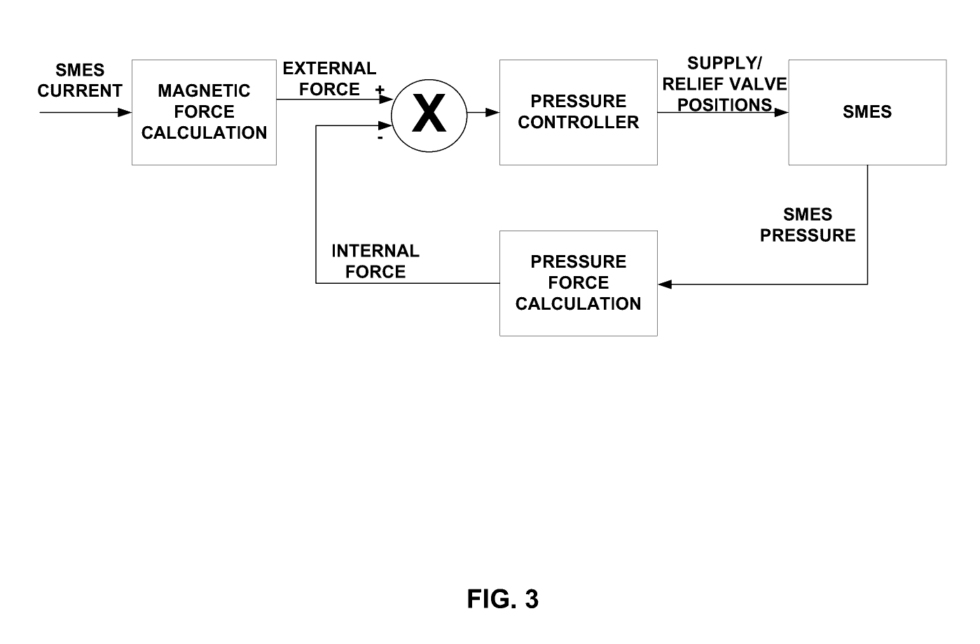

FIG. 3 is a schematic block diagram illustrating an example superconducting magnetic energy storage (SMES) device. A controller balances the pressure inside SMES 6 with the magnetic forces created by superconducting coil 30. The internal pressure may be managed proportionally to the current in the superconducting coil 30, or proportionally to the field strength, to counteract the magnetic force and reduce the require mass of the structure.

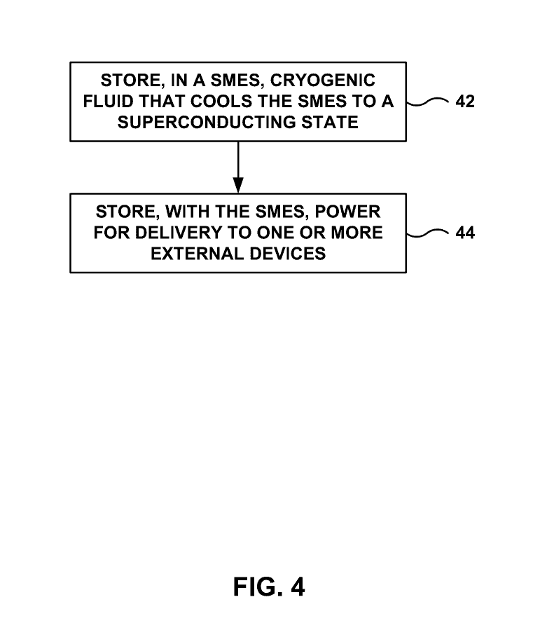

FIG. 4 is a flow diagram illustrating example techniques for a superconducting magnetic energy storage (SMES). In some examples, SMES 6 of FIG. 2 may be configured to store cryogenic fluid 34 (42). Cryogenic fluid 34 may include liquid helium or liquid hydrogen. Cryogenic fluid 34 may cool SMES 6 to a superconducting state. SMES 6 may receive power from power source 12 of FIG. 1. When SMES 6 is in a superconducting state, SMES 6 may store power from power source 12 for delivery to one or more external devices (e.g., load 10) (44). The external devices may include the motor of a vehicle, rocket, or spacecraft, or any other device that consumes power. In some examples, SMES 6 may output cryogenic fluid 34 to the one or more external devices which may provide fuel and/or cooling to the one or more external devices. In some examples, SMES 6 may output electric power to power converter 8 or output power directly to the one or more external devices.

Various examples of this disclosure have been described. These and other examples are within the scope of the following claims.

What is claimed is:

1. A superconducting magnetic energy storage (SMES) device comprising:
a toroidal housing configured to store a cryogenic fluid that cools the SMES to a superconducting state; and
a coil, wherein the coil is configured to be in the superconducting state from cooling from the cryogenic fluid and configured to store power for delivery to one or more external devices.

2. The SMES device of claim 1, wherein the cryogenic fluid cools the one or more external devices to a superconducting state.

3. The SMES device of claim 1, wherein the toroidal housing further comprises a plurality of chambers, wherein at least one chamber in the plurality of chambers stores the cryogenic fluid.

4. The SMES device of claim 3, wherein the coil is wrapped around a chamber of the plurality of chambers.

5. The SMES device of claim 3, wherein the plurality of chambers comprise concentric chambers.

6. The SMES device of claim 3, wherein a first chamber of the plurality of chambers includes a vacuum cryostat and a second chamber of the plurality of chambers includes the cryogenic fluid.

7. The SMES device of claim 3, wherein the plurality of chambers includes a cooling reservoir, wherein the cooling reservoir provides the cryogenic fluid to the one or more external devices.

8. The SMES device of claim 1, wherein the cryogenic fluid is provided to one or more external devices as fuel, wherein the cryogenic fluid comprises one or more of:
liquid hydrogen, liquid helium or liquid natural gas.

9. The SMES device of claim 1, wherein the toroidal housing further comprises a pressurized gas.

10. The SMES device of claim 9, wherein the pressurized gas comprises one or more of:
helium, hydrogen, or nitrogen.

11. A system comprising:
a controller;
a gas pressurization tank;
a power converter; and
a superconducting magnetic energy storage (SMES) device comprising:
a cryogenic fluid that cools the SMES to a superconducting state; and
a toroidal housing configured to store the cryogenic fluid;
a coil, wherein the coil is configured to be in the superconducting state from cooling from the cryogenic fluid and configured to store power for delivery to one or more external devices.

12. The system of claim 11, wherein the cryogenic fluid cools the one or more external devices to a superconducting state.

13. The system of claim 11, wherein the toroidal housing further comprises a plurality of chambers, wherein at least one chamber in the plurality of chambers stores the cryogenic fluid.

14. The system of claim 13, wherein the coil is wrapped around a chamber of the plurality of chambers.

15. The system of claim 13, wherein the plurality of chambers comprise concentric chambers.

16. The system of claim 13, wherein a first chamber of the plurality of chambers includes a vacuum cryostat and a second chamber of the plurality of chambers includes the cryogenic fluid.

17. The system of claim 13, wherein the plurality of chambers includes a cooling reservoir, wherein the cooling reservoir provides the cryogenic fluid to the one or more external devices.

18. The system of claim 11, wherein the cryogenic fluid is provided to one or more external devices as fuel, wherein the cryogenic fluid comprises one or more of: liquid hydrogen, liquid helium, or liquid natural gas, wherein the gas pressurization tank includes a pressurized gas, and wherein the pressurized gas comprises one or more of: helium, hydrogen, or nitrogen.

19. A method for a superconducting magnetic energy storage (SMES) device comprising:
storing, in the SMES device, a cryogenic fluid that cools the SMES to a superconducting state; and
storing, with the SMES device being in the superconducting state, power for delivery to one or more external devices.

20. The method of claim 19,
wherein storing the cryogenic fluid comprises storing the cryogenic fluid in a toroidal housing, and
wherein storing power comprises storing in a coil wrapped around a chamber within the toroidal housing, wherein the coil is configured to be in the superconducting state from cooling from the cryogenic fluid.
